(19) United States
(12) Patent Application Publication
(10) Pub. No.: US 2022/0032674 A1
(43) Pub. Date: Feb. 3, 2022

(54) THERMAL TRANSFER SHEET AND PRINT

(71) Applicant: Dai Nippon Printing Co., Ltd., Tokyo (JP)

(72) Inventors: Yasushi YONEYAMA, Tokyo (JP); Ikumi WASHIE, Tokyo (JP)

(73) Assignee: Dai Nippon Printing Co., Ltd., Tokyo (JP)

(21) Appl. No.: 17/275,719

(22) PCT Filed: Sep. 26, 2019
(86) PCT No.: PCT/JP2019/037822

§ 371 Date: Mar. 12, 2021

(30) Foreign Application Priority Data
Sep. 28, 2018 (JP) 2018-185350

(51) Int. Cl. B41M 5/42; B32B 27/20; B32B 27/30

(52) U.S. Cl. CPC B41M 5/423; B32B 2559/00; B32B 27/308; B32B 27/20

(57) ABSTRACT

To provide a thermal transfer sheet enabling production of a print having extremely good abrasion resistance and a print having extremely good abrasion resistance.

A thermal transfer sheet 100 in which a transfer layer 10 is provided on one surface of a substrate 1, wherein the transfer layer 10 has a single-layer structure composed only of a protective layer 5 or a layered structure including a protective layer 10 located nearest from a side of the substrate, and the protective layer 5 contains an acrylic resin and an ethoxylated alcohol.

### TECHNICAL FIELD

The present invention relates to a thermal transfer sheet and a print.

### BACKGROUND ART

Formation of a thermal transferred image on a transfer receiving article using a sublimation-type thermal transfer method has been widely performed because of excellent transparency, high reproducibility and gradation of neutral tints, and easy formability of a high quality image equivalent to conventional full color photographic images. As prints in which a thermal transferred image is formed on a transfer receiving article, there are known cards for use in arcade game machines, digital photographs, and ID cards such as identity cards, driver's licenses, and membership cards, which are used in many fields.

By the way, in a thermal transferred image to be formed by the above sublimation-type thermal transfer method, the colorant is not a pigment but a dye having a relatively low molecular weight. Thus, a print in which the thermal transferred image is formed on a transfer receiving article by the above sublimation-type thermal transfer method inherently includes a problem of insufficient durability such as abrasion resistance. Against such a problem, in prints in which the thermal transferred image is formed on a transfer receiving article by the above sublimation-type thermal transfer method, a protective layer is transferred on the thermal transferred image to thereby improve the durability. As thermal transfer sheets for use in transfer of the protective layer, ones suggested in, for example, Patent Literatures 1 and 2 are known.

With the diversification of use forms of prints, prints to be used have been recently required to have higher abrasion resistance. For example, in the field of the arcade games described above, a print may be abrasively used on the board during the gaming. Thus, prints for use in such fields have been required to have extremely high abrasion resistance.

### CITATION LIST

### Patent Literature

Patent Literature 1: Japanese Patent Laid-Open No. 2005-262690
Patent Literature 2: Japanese Patent Laid-Open No. 2002-240404

### SUMMARY OF INVENTION

### Technical Problem

The present invention has been made in view of such circumstances, and the present invention aims principally to provide a thermal transfer sheet enabling production of a print having extremely good abrasion resistance and a print having extremely good abrasion resistance.

### Solution to Problem

A thermal transfer sheet according to an embodiment of the present disclosure for solving the above problems is a thermal transfer sheet in which a transfer layer is provided on one surface of a substrate. The transfer layer has a single-layer structure composed only of a protective layer or a layered structure including a protective layer located nearest from the side of the substrate. The protective layer contains an acrylic resin and an ethoxylated alcohol

The ethoxylated alcohol may have a number average molecular weight (Mn) of 2000 or less. The ethoxylated alcohol may have an HLB value of 12 or less. The content of the ethoxylated alcohol may be 2% by mass or more based on the total mass of the protective layer. The protective layer may contain polyethylene wax.

A print according to an embodiment of the present disclosure for solving the above problems is a print in which a protective layer is provided on an image body having an image. The protective layer contains an acrylic resin and an ethoxylated alcohol.

### Advantageous Effects of Invention

According to the thermal transfer sheet of the present disclosure, it is possible to produce a print having extremely good abrasion resistance. The print of the present disclosure has extremely good abrasion resistance.

### BRIEF DESCRIPTION OF DRAWINGS

FIG. 1 is a schematic cross-sectional view showing an exemplary thermal transfer sheet of the present disclosure.

FIG. 2 is a schematic cross-sectional view showing an exemplary thermal transfer sheet of the present disclosure.

FIG. 3 is a schematic cross-sectional view showing an exemplary thermal transfer sheet of the present disclosure.

FIG. 4 is a schematic cross-sectional view showing an exemplary print of the present disclosure.

### DESCRIPTION OF EMBODIMENTS

### <<Thermal Transfer Sheet>>

Hereinbelow, a thermal transfer sheet 100 according to an embodiment of the present disclosure (hereinbelow, referred to as the thermal transfer sheet of the present disclosure) will be described specifically using the drawings.

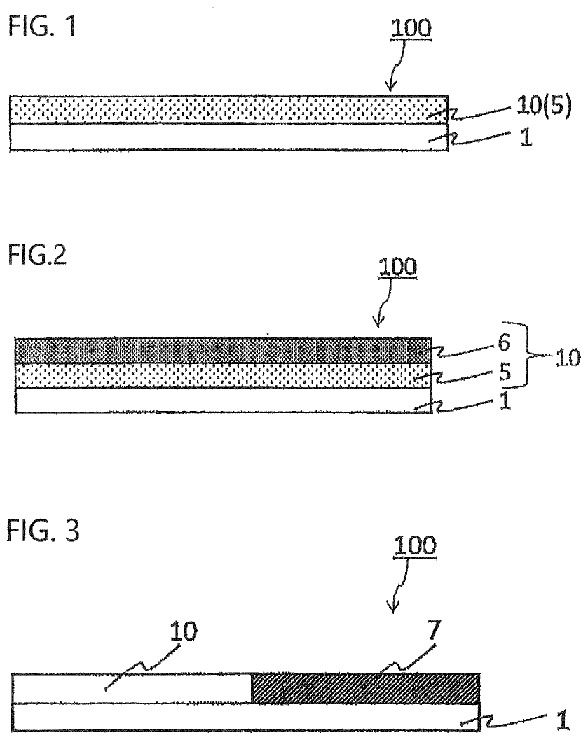

As shown in FIG. 1 to FIG. 3, the thermal transfer sheet 100 of the present disclosure includes a substrate 1 and a transfer layer 10 provided on the substrate 1. The transfer layer 10 is a layer that is released at the surface of the transfer layer 10 on the side of the substrate 1 and moves onto a transfer receiving article.

### (Substrate)

The substrate 1 is an essential component in the thermal transfer sheet 100 of the present disclosure and supports the transfer layer 10 and the like. There is no limitation on the material of the substrate 1, and the material desirably has heat resistance and mechanical characteristics. Examples of the substrate 1 like this can include various plastic films or sheets of polyesters such as polyethylene terephthalate, polycarbonate, polyimides, polyether imides, cellulose derivatives, polyethylene, polypropylene, styrene resins, acrylic resins, polyvinyl chloride, polyvinylidene chloride, nylon, or polyether ether ketone. The thickness of the substrate 1 may be appropriately selected depending on the kind of the material of the substrate, so that the strength, heat resistance and the like of the substrate sheet lie in appropriate ranges, and is generally 2.5 μm or more and 100 μm or less.

### (Transfer Layer)

As shown in FIG. 1 to FIG. 3, the transfer layer 10 is provided on the substrate 1. The transfer layer 10 has a single-layer structure composed only of a protective layer 5 (see FIG. 1) or has a layered structure including a protective layer 5 located nearest from the side of the substrate 1 (see FIG. 2). The transfer layer 10 of the aspect shown in FIG. 2 has a layered structure of the protective layer 5 and an adhesive layer 6 which are layered in this order from the side of the substrate 1. The transfer layer 10 of the aspect shown in FIG. 3 includes both a single-layer structure and a layered structure, and the description of the protective layer 5 is omitted. The transfer layer 10 is not limited to the aspect shown and is only required to satisfy a condition of inclusion of the protective layer 5. For example, in the aspect shown in FIG. 2, the transfer layer 10 may have a configuration in which a primer layer intended to improve the adhesion between the protective layer 5 and the adhesive layer 6 is provided between the protective layer 5 and the adhesive layer, or may have a configuration in which various functional layers are provided on the protective layer 5. The protective layer 5 constituting the transfer layer 10 is the layer located on the outermost surface when the transfer layer 10 is transferred on a transfer receiving article. Accordingly, when the transfer layer 10 has a layered structure, the protective layer 5 is located nearest from the side of the substrate 1, among the layers constituting the transfer layer 10.

### (Protective Layer)

The protective layer 5 contains an acrylic resin and an ethoxylated alcohol as essential components. According to the thermal transfer sheet 100 of the present disclosure, in which the protective layer 5 constituting the transfer layer 10 contains an acrylic resin and an ethoxylated alcohol, it is possible to produce a print having extremely good abrasion resistance by transferring the transfer layer 10 including the protective layer 5 on a transfer receiving article. Specifically, according to the thermal transfer sheet 100 of the present disclosure, it is possible to produce a print in which the protective layer 5 is located on the outermost surface by transferring the transfer layer 10 on a transfer receiving article, and it is possible to make the abrasion resistance of the print extremely good by imparting extremely good abrasion resistance to this protective layer 5.

### <Acrylic Resin>

The acrylic resin referred to herein means a polymer of acrylic acid or methacrylic acid monomer or a derivative thereof, a polymer of acrylic ester or methacrylic acid ester monomer or a derivative thereof, a copolymer of acrylic acid or methacrylic acid monomer and another monomer or a derivative thereof, or a copolymer of acrylic ester or methacrylic acid ester monomer and another monomer or a derivative thereof. The protective layer 5 may contain one acrylic resin or may contain two or more acrylic resins.

Examples of the acrylic acid ester or methacrylic acid ester monomer can include alkyl acrylates and alkyl methacrylates. Specific examples thereof can include methyl acrylate, methyl methacrylate, ethyl acrylate, ethyl methacrylate, butyl acrylate, butyl methacrylate, lauryl acrylate, lauryl methacrylate, 2-hydroxyethyl acrylate, 2-hydroxyethyl methacrylate, 2-hydroxybutyl acrylate, 2-hydroxybutyl methacrylate, 2-hydroxy-3-phenoxypropyl acrylate, and 2-hydroxy-3-phenoxypropyl methacrylate.

Examples of other monomers than these can include aromatic hydrocarbons, aryl group-containing compounds, amide group-containing compounds, and vinyl chloride, styrene, benzylstyrene, phenoxyethyl methacrylate, acrylamide, and methacrylamide. Monomers other than these may be acceptable.

As the acrylic resin, it is also possible to use an acrylic polyol resin or the like obtained by copolymerizing one or two or more of acrylic acid alkyl esters, one or two or more of (meth)acrylic acid esters having a hydroxyl group in the molecule such as 2-hydroxyethyl (meth)acrylate, 2-hydroxybutyl (meth)acrylate, and 2-hydroxy-3-phenoxypropyl (meth)acrylate, and, if necessary, one or two or more of another polymerizable monomers such as styrene.

Among these acrylic resins, polymethyl methacrylate is a suitable acrylic resin in respect of being capable of making the abrasion resistance of the protective layer 5 better and of making the transparency of the protective layer 5 good. Thus, the protective layer 5 preferably contains polymethyl methacrylate as the acrylic resin.

The molecular weight of the acrylic resin contained in the protective layer 5 is not limited. The molecular weight of the acrylic resin, as the weight average molecular weight (Mw), is preferably 25000 or more and 300000 or less, more preferably 27000 or more and 100000 or less, particularly preferably 35000 or more and 100000 or less. The weight average molecular weight (Mw) referred to herein means a value in terms of polystyrene, as measured by GPC (gel permeation chromatography) in compliance with JIS-K-7252-1 (2008). The same applies to the number average molecular weight (Mn) mentioned below.

The protective layer 5 may contain another resin component as a resin component, along with the acrylic resin described above. When the protective layer 5 contains another resin component along with the acrylic resin, the content of the resin components including the acrylic resin is preferably more than 50% by mass based on the total mass of the protective layer 5. The upper limit of the content of the resin components including the acrylic resin is only required to be determined as appropriate in consideration of the content of the ethoxylated alcohol, the content of optional additives, and the like. When the content of the resin components including the acrylic resin is made to be larger than 50% by mass based on the total mass of the protective layer 5, it is possible to make the adhesion between a transfer receiving article and the transfer layer and the film strength of the protective layer better on transferring the transfer layer 10 including the protective layer 5 on the transfer receiving article. In this case, the content of the acrylic resin is preferably more than 50% by mass, more preferably 70% by mass or more, based on the summed mass of the resin components including the acrylic resin. When the content of the acrylic resin is made to be more than 50% by mass based on the summed mass of the resin components including the acrylic resin, it is possible to impart good transparency to the protective layer 5 as well as to further improve the abrasion resistance.

In contrast, when the protective layer 5 contains no other resin components and contains only the acrylic resin as the resin component, the content of the acrylic resin is preferably more than 50% by mass based on the total mass of the protective layer 5.

Examples of other resin components can include polyester, polystyrene, polyurethane, resins obtained by silicone-modifying each of these resins, cured products of an active ray-curable resin, and any blends of these resins.

### <Ethoxylated Alcohol>

The ethoxylated alcohol referred to herein means a compound obtained by ethoxylating an alcohol with ethylene oxide, and examples thereof can include compounds represented by the following general formula (A):

R—O—(C₂H₄O)ₙ—H (general formula A)

Wherein R is an alkyl group having 10 or more and 50 or less carbon atoms. n is 2 or more and 50 or less. The alkyl group may be a linear chain or a branched chain.

The ethoxylated alcohol serves to impart extremely good abrasion resistance to the protective layer 5. When the protective layer contains no acrylic resin and contains a different resin, it is not possible to impart extremely good abrasion resistance to the protective layer even if this protective layer contains an ethoxylated alcohol. Even if the protective layer contains an acrylic resin, when the layer contains no ethoxylated alcohol, it is not possible to impart extremely good abrasion resistance to the protective layer. In other words, in the thermal transfer sheet 100 of the present disclosure, when the protective layer 5 is allowed to contain both an acrylic resin and an ethoxylated alcohol, it is possible to impart extremely good abrasion resistance to the protective layer 5 because of the synergistic effect of these components.

The molecular weight of the ethoxylated alcohol contained in the protective layer 5, as the number average molecular weight (Mn), is preferably 2000 or less. When a coating liquid for forming a protective layer is prepared by dissolving or dispersing an acrylic resin and an ethoxylated alcohol in an appropriate organic solvent such as methyl ethyl ketone, it is possible to easily make this coating liquid into an ink and to make the production suitability on forming the protective layer good by use of an ethoxylated alcohol having a number average molecular weight (Mn) of 2000 or less as the ethoxylated alcohol. In respect that a similar effect can be expected, the HLB value of the ethoxylated alcohol contained in the protective layer 5 is preferably 12 or less. The protective layer 5 may contain one ethoxylated alcohol or may contain two or more ethoxylated alcohols different in the number average molecular weight (Mn), the HLB value, and the like. The HLB value referred to herein is an HLB value as measured by the Griffin method.

When the protective layer 5 is allowed to contain an ethoxylated alcohol having a number average molecular weight (Mn) of 500 or more and 2000 or less, preferably 700 or more and 2000 or less, more preferably 1000 or more and 1800 or less, it is possible to enhance the above production suitability as well as to make the abrasion resistance better. When the protective layer 5 is allowed to contain an ethoxylated alcohol having an HLB value of 1 or more and 12 or less, preferably 2 or more and 12 or less, more preferably 5 or less and 12 or less, further preferably 7 or more and 12 or less, it is possible to enhance the above production suitability as well as to make the abrasion resistance better.

Addition of a small amount of an ethoxylated alcohol enables extremely good abrasion resistance to be imparted to the protective layer 5. Accordingly, the content of the ethoxylated alcohol based on the total mass of the protective layer 5 is not limited and is preferably 2% by mass or more, more preferably 4% by mass or more, further preferably 8% by mass or more. Particularly, the ethoxylated alcohol contained in such a content is preferably an ethoxylated alcohol having a number average molecular weight (Mn) and an HLB value within the ranges described above. The upper limit of the content of the ethoxylated alcohol is only required to be determined as appropriate in consideration of the content of the acrylic resin and the content of optional components, and an example thereof is 50% by mass or less.

The protective layer 5 may also contain various additives. Examples of the additives can include polyethylene waxes, various silicone oils, metal soaps such as zinc stearate, zinc stearyl phosphate, calcium stearate, and magnesium stearate, release agents such as fatty acid amides, polyethylene waxes, carnauba waxes, and paraffin waxes, known ultraviolet absorbing agents such as benzophenone type, benzotriazole type, benzoate type, triazine type, titanium oxide, and zinc oxide ultraviolet absorbing agents, light stabilizers such as hindered amine type and Ni-chelate type light stabilizers, and antioxidants such as hindered phenol type, sulfur type, phosphorus type, and lactone type antioxidants.

Among these, a polyethylene wax is a suitable additive in respect of being capable of imparting good abrasion resistance to the protective layer 5 while enhancing the degree of freedom in designing the acrylic resin and the ethoxylated alcohol to be contained in protective layer 5, for example, the degree of freedom of the physical properties of the acrylic resin and the ethoxylated alcohol and the content thereof. The content of the polyethylene wax is preferably 0.5% by mass or more and 15% by mass or less, more preferably 1% by mass or more and 10% by mass or less, even more preferably 2% by mass or more and 8% by mass or less, based on the total mass of the protective layer 5.

There is also no particular limitation on a method for forming the protective layer 5, and the protective layer can be formed by dispersing or dissolving an acrylic resin, an ethoxylated alcohol, and various resin components and various additives to be used as required in a suitable solvent to prepare a coating liquid for protective layer, applying this coating liquid on the substrate 1 or an optional layer provided on the substrate 1 (e.g., the release layer mentioned below), and drying the applied liquid. Examples of the coating method can include a gravure printing method, a screen printing method, and a reverse roll coating method using a gravure printing plate. Coating methods other than these methods also may be used. The same applies to coating methods for various coating liquids mentioned below.

There is not particular limitation on the thickness of the protective layer 5, and the thickness is preferably 0.1 μm or more and 8 μm or less, more preferably 0.3 μm or more and 5 μm or less. Setting the thickness of the protective layer 5 to a preferred thickness further improves the abrasion resistance of the protective layer as well as can make the foil cutting property of the transfer layer 10 good on transferring the transfer layer 10 including the protective layer 5.

The protective layer 5 described above has good adhesion with a transfer receiving article and a release property. Thus, even when the transfer layer 10 has a single-layer structure composed only of the protective layer 5, it is possible to release the transfer layer 10 from the substrate 1 and to cause the released transfer layer 10 to adhere onto a transfer receiving article. In particular, when any other optional layer is provided on the protective layer 5, that is, when the transfer layer 10 has a layered structure including the protective layer 5, the ethoxylated alcohol contained in the protective layer 5 tends to decrease the flanking resistance of the other optional layer. In consideration of such respects, in the thermal transfer sheet 100 of the present disclosure, the transfer layer 10 preferably has a single-layer structure composed only of the protective layer 5.

### (Adhesive Layer)

As shown in FIG. 2, the transfer layer 10 may have a layered structure of a protective layer 5 and an adhesive layer 6 which are layered in this order from the side of the substrate 1.

There is no particular limitation on the component having adhesion, and examples thereof can include resin components, such as urethane resins, polyolefins such as α-olefin—maleic anhydride, polyesters, acrylic resins, epoxy resins, urea resins, melamine resins, phenol resins, polyvinyl acetate, vinyl chloride—vinyl acetate copolymers, and cyanoacrylate resins.

The thickness of the adhesive layer 6 is preferably 0.5 μm or more and 10 μm or less. There is no limitation on a method for forming the adhesive layer, and the adhesive layer may be formed by dispersing or dissolving the adhesive exemplified above and additives to be added as required in an appropriate solvent to prepare a coating liquid for adhesive layer, applying this coating liquid onto the protective layer 5 or an optional layer provided on the protective layer 5, and drying the applied liquid.

### (Release Layer)

A release layer (not shown) may be provided between the substrate 1 and the transfer layer 10. Examples of the components of the release layer can include waxes, silicone wax, silicone resins, silicone-modified resins, fluorine resins, fluorine-modified resins, polyvinyl alcohol, acrylic resin, thermally crosslinkable epoxy—amino resins, and thermally crosslinkable alkyd—amino resins.

The thickness of the release layer is generally 0.5 μm or more and 5 μm or less. There is no limitation on a method for forming the release layer, and, for example, the release layer may be formed by dispersing or dissolving the above components in an appropriate solvent to prepare a coating liquid for release layer, applying this coating liquid onto the substrate 1, and drying the applied liquid.

When the release layer is provided on the substrate 1, the surface of the substrate 1 on the side of the release layer may be subjected to adhesive treatment in order to improve the adhesion between the substrate 1 and the release layer. As the adhesive treatment, a known resin surface modification technique, for example, corona discharge treatment, flame treatment, ozone treatment, ultraviolet treatment, radiation treatment, roughening treatment, chemical treatment, plasma treatment, low-temperature treatment, primer treatment, and grafting treatment, can be applied as it is. Two or more of these treatments also can be used in combination.

### (Colorant Layer)

As shown in FIG. 3, a colorant layer 7 may be provided on one surface of the substrate 1 so as to be frame sequential to the transfer layer 10 described above. In the thermal transfer sheet 100 of the aspect shown in FIG. 3, a single colorant layer 7 is provided on one surface. On one surface of the substrate, a plurality of colorant layers, for example, a yellow colorant layer, a magenta colorant layer, a cyan colorant layer, a black colorant layer, and the like may be provided in a frame-sequential manner. When the colorant layer 7 and the transfer layer 10 are used to form “one unit”, the “one unit” can be repeatedly provided on one surface of the substrate 1.

According to the thermal transfer sheet of the aspect shown in FIG. 3, it is possible to form a thermal transferred image on a transfer receiving article and transfer the transfer layer 10 onto the formed thermal transferred image using one thermal transfer sheet 100. An exemplary colorant layer 7 contains a binder resin and a sublimable dye.

### (Colorant Primer Layer)

A colorant primer layer (not shown), which is intended for improving the adhesion between the substrate 1 and the colorant layer 7, may be provided between the substrate 1 and the colorant layer 7. There is no particular limitation on the thickness of the colorant primer layer, and the thickness is generally 0.02 μm or more and 1 μm or less.

### (Back Face Layer)

A back face layer (not shown) may also be provided on the other surface of the substrate 1. The back face layer is an optional constituent in the thermal transfer sheet of the present disclosure. The thickness of the back face layer is preferably 0.1 μm or more and 5 μm or less, more preferably 0.3 μm or more and 2 μm or less, in respect of improvement in the heat resistance and the like.

### (Transfer Receiving Article)

Examples of the transfer receiving article onto which the transfer layer 10 of the thermal transfer sheet 100 of the present disclosure is to be transferred include thermal transfer image-receiving sheets, plain paper, wood-free paper, tracing paper, plastic films, and plastic cards mainly composed of vinyl chloride, a vinyl chloride-vinyl acetate copolymer, or polycarbonate. As the transfer receiving article, one having a predetermined image also can be used. The transfer receiving article may be colored or may have transparency.

### (Method for Transferring Transfer Layer)

There is no particular limitation on a method for transferring the transfer layer onto a transfer receiving article, and the method can be performed using, for example, a thermal transfer printer having a heating device such as a thermal head, or a heating device such as a hot stamp or a heat roll.

### <<Print>>

Subsequently, a print according to the embodiment of the present disclosure (hereinafter, the print is referred to as the print of the present disclosure) will be described.

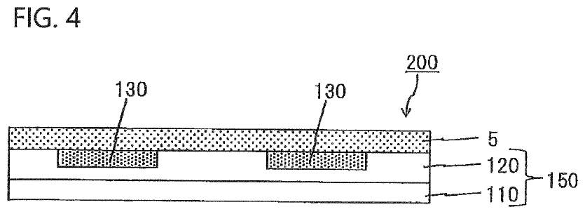

As shown in FIG. 4, the print 200 of the present disclosure has a configuration in which a protective layer 5 is provided on an image body 150.

### (Image Body)

The image body 150 has an image 130. The image 130 included in the image body 150 is not limited in any way. Examples of the image 130 included in the image body 150 can include images formed by a sublimation-type thermal transfer method, a melt-type thermal transfer method, an inkjet printing method, a toner printing method (laser printing method), or the like. The image may be formed by a method other than these methods. The image body 150 of the aspect shown in FIG. 4 has a layered structure including a support 110 and an image layer 120 in which an image 130 is formed. The image body 150 may have a single-layer structure composed only of the image layer 120 including an image. Alternatively, in the aspect shown in FIG. 4, the support 110 may have a layered structure composed of a plurality of constituent members. The support 110 can be appropriately selected for use from those described as the transfer receiving article and the like. The configuration of the image layer 120 is only required to be determined as appropriate in consideration of the image forming method for forming the image 130 and the like.

### (Protective Layer)

The protective layer 5 provided on the image body 150 contains an acrylic resin and an ethoxylated alcohol. Using the print 200 of the present disclosure having such a protective layer 5, it is possible to make the abrasion resistance of the print 200 extremely good.

The protective layer 5 constituting the print 200 of the present disclosure can be appropriately selected for use from the various configurations of the protective layer 5 described in the above thermal transfer sheet 100 of the present disclosure, and thus a detailed description is omitted here.

In the aspect shown in FIG. 4, the protective layer 5 is provided directly on the image body 150, but a different layer may be provided between the image body 150 and the protective layer 5. For example, an adhesive layer (not shown) may be provided between the image body 150 and the protective layer 5.

In the aspect shown in FIG. 4, the protective layer 5 is located on the outermost surface of the print 200, but a different layer may be provided on the protective layer 5. In consideration of the abrasion resistance of the print 200, the protective layer 5 is preferably located on the outermost surface of the print 200.

There is no limitation on a method for producing the print 200 of the present disclosure. Examples of the method can include a production method including transferring the transfer layer 10 (protective layer 5) of the above thermal transfer sheet 100 of the present disclosure (see FIG. 1 and FIG. 2) on the image body 150 and a production method including bonding the image body 150 to the protective layer 5 (the transfer layer 10 may be acceptable) via an adhesive layer (an adhesive, an adhesive film, or an adhesive sheet may be acceptable). The print 200 may be produced by a method other than these.

Although the resin and the like constituting each layer are herein described exemplarily, each of these resins may be a homopolymer of a monomer constituting each resin, or a copolymer of the main component monomer constituting each resin and one or more other polymers, or a derivative thereof. For example, the above acrylic resin is only required to include a monomer of acrylic acid or methacrylic acid, or an acrylic acid ester or methacrylic acid ester as the main component. The acrylic resin also may be a modified product of these resins. A resin other than those described herein also may be used.

### EXAMPLES

Next, the present invention will be described more concretely with reference to examples and comparative examples. Hereinbelow, unless otherwise particularly specified, the expression of part(s) or % means that by mass, representing a formulation not in terms of solid content.

### Example 1

A coating liquid for protective layer 1 having the following composition was applied on a polyethylene terephthalate (PET) film having a thickness of 4.5 μm, and the applied liquid was dried to form a protective layer having a thickness of 1 μm. Thus, provided was a thermal transfer sheet of Example 1, in which a transfer layer composed only of the protective layer was provided on a substrate.

### <Coating Liquid for Protective Layer 1>

| | | |
|---|---|---|
| Acrylic resin | 94 | parts |
| (DIANAL(R) BR-83, Mitsubishi Chemical Corporation) | | |
| Ethoxylated alcohol (Mn: 1400, HLB value: 10) | 1 | part |
| (UNITHOX(R) 750 ethoxylate, Baker Hughes Company) | | |
| Polyethylene wax | 5 | parts |
| Methyl ethyl ketone | 250 | parts |
| Toluene | 250 | parts |

### Example 2

A thermal transfer sheet of Example 2 was obtained exactly in the same manner as in Example 1 except that the coating liquid for protective layer 1 was replaced by a coating liquid for protective layer 2 having the following composition to form the protective layer.

### <Coating Liquid for Protective Layer 2>

| | | |
|---|---|---|
| Acrylic resin | 85 | parts |
| (DIANAL(R) BR-83, Mitsubishi Chemical Corporation) | | |
| Ethoxylated alcohol (Mn: 1400, HLB value: 10) | 10 | parts |
| (UNITHOX(R) 750 ethoxylate, Baker Hughes Company) | | |
| Polyethylene wax | 5 | parts |
| Methyl ethyl ketone | 250 | parts |
| Toluene | 250 | parts |

### Example 3

A thermal transfer sheet of Example 3 was obtained exactly in the same manner as in Example 1 except that the coating liquid for protective layer 1 was replaced by a coating liquid for protective layer 3 having the following composition to form the protective layer.

### <Coating Liquid for Protective Layer 3>

| | | |
|---|---|---|
| Acrylic resin | 90 | parts |
| (DIANAL(R) BR-83, Mitsubishi Chemical Corporation) | | |
| Ethoxylated alcohol (Mn: 575, HLB value: 4) | 10 | parts |
| (UNITHOX(R) 420 ethoxylate, Baker Hughes Company) | | |
| Methyl ethyl ketone | 250 | parts |
| Toluene | 250 | parts |

### Example 4

A thermal transfer sheet of Example 4 was obtained exactly in the same manner as in Example 1 except that the coating liquid for protective layer 1 was replaced by a coating liquid for protective layer 4 having the following composition to form the protective layer.

### <Coating Liquid for Protective Layer 4>

| | | |
|---|---|---|
| Acrylic resin | 90 | parts |
| DIANAL(R) BR-83, Mitsubishi Chemical Corporation) | | |
| Ethoxylated alcohol (Mn: 920, HLB value: 10) | 10 | parts |
| (UNITHOX(R) 450 ethoxylate, Baker Hughes Company) | | |
| Methyl ethyl ketone | 250 | parts |
| Toluene | 250 | parts |

### Example 5

A thermal transfer sheet of Example 5 was obtained exactly in the same manner as in Example 1 except that the coating liquid for protective layer 1 was replaced by a coating liquid for protective layer 5 having the following composition to form the protective layer.

### <Coating Liquid for Protective Layer 5>

| | | |
|---|---|---|
| Acrylic resin | 85 | parts |
| (DIANAL(R) BR-80, Mitsubishi Chemical Corporation) | | |
| Ethoxylated alcohol (Mn: 1400, HLB value: 10) | 10 | parts |
| (UNITHOX(R) 750 ethoxylate, Baker Hughes Company) | | |
| Polyethylene wax | 5 | parts |
| Methyl ethyl ketone | 250 | parts |
| Toluene | 250 | parts |

### Example 6

A thermal transfer sheet of Example 6 was obtained exactly in the same manner as in Example 1 except that the coating liquid for protective layer 1 was replaced by a coating liquid for protective layer 6 having the following composition to form the protective layer.

### <Coating Liquid for Protective Layer 6>

| | | |
|---|---|---|
| Acrylic resin | 85 | parts |
| (DIANAL(R) BR-87, Mitsubishi Chemical Corporation) | | |
| Ethoxylated alcohol (Mn: 1400, HLB value: 10) | 10 | parts |
| (UNITHOX(R) 750 ethoxylate, Baker Hughes Company) | | |
| Polyethylene wax | 5 | parts |
| Methyl ethyl ketone | 250 | parts |
| Toluene | 250 | parts |

### Example 7

A thermal transfer sheet of Example 7 was obtained exactly in the same manner as in Example 1 except that the coating liquid for protective layer 1 was replaced by a coating liquid for protective layer 7 having the following composition to form the protective layer.

### <Coating Liquid for Protective Layer 7>

| | | |
|---|---|---|
| Acrylic resin | 95 | parts |
| (DIANAL(R) BR-83, Mitsubishi Chemical Corporation) | | |
| Ethoxylated alcohol (Mn: 1400, HLB value: 10) | 5 | parts |
| (UNITHOX(R) 750 ethoxylate, Baker Hughes Company) | | |
| Methyl ethyl ketone | 250 | parts |
| Toluene | 250 | parts |

### Example 8

A thermal transfer sheet of Example 8 was obtained exactly in the same manner as in Example 1 except that the coating liquid for protective layer 1 was replaced by a coating liquid for protective layer 8 having the following composition to form the protective layer.

### <Coating Liquid for Protective Layer 8>

| | | |
|---|---|---|
| Acrylic resin | 90 | parts |
| (DIANAL(R) BR-83, Mitsubishi Chemical Corporation) | | |
| Ethoxylated alcohol (Mn: 1400, HLB value: 10) | 10 | parts |
| (UNITHOX(R) 750 ethoxylate, Baker Hughes Company | | |
| Methyl ethyl ketone | 250 | parts |
| Toluene | 250 | parts |

### Example 9

A thermal transfer sheet of Example 9 was obtained exactly in the same manner as in Example 1 except that the coating liquid for protective layer 1 was replaced by a coating liquid for protective layer 9 having the following composition to form the protective layer.

### <Coating Liquid for Protective Layer 9>

| | | |
|---|---|---|
| Acrylic resin | 70 | parts |
| (DIANAL(R) BR-83, Mitsubishi Chemical Corporation) | | |
| Ethoxylated alcohol (Mn: 1400, HLB value: 10) | 30 | parts |
| (UNITHOX(R) 750 ethoxylate, Baker Hughes Company) | | |
| Methyl ethyl ketone | 250 | parts |
| Toluene | 250 | parts |

### Example 10

A protective layer was formed by using a method similar to that in Example 1. On this protective layer, a coating liquid for adhesive layer having the following composition was applied, and the applied liquid was dried to form an adhesive layer having a thickness of 1 μm. Thus, provided was a thermal transfer sheet of Example 10, in which the protective layer and the adhesive layer were layered in this order on the substrate.

### <Coating Liquid for Adhesive Layer>

| | | |
|---|---|---|
| Acrylic resin | 16 | parts |
| Vinyl chloride-vinyl acetate copolymer | 4 | parts |
| Methyl ethyl ketone | 40 | parts |
| Toluene | 40 | parts |

### Example 11

A thermal transfer sheet of Example 11 was obtained exactly in the same manner as in Example 1 except that the coating liquid for protective layer 1 was replaced by the coating liquid for protective layer 5 having the composition described above to form the protective layer having a thickness of 0.5 μm.

### Example 12

A thermal transfer sheet of Example 12 was obtained exactly in the same manner as in Example 1 except that the coating liquid for protective layer 1 was replaced by the coating liquid for protective layer 5 having the composition described above to form the protective layer having a thickness of 2 μm.

### Example 13

A thermal transfer sheet of Example 13 was obtained exactly in the same manner as in Example 1 except that the coating liquid for protective layer 1 was replaced by a coating liquid for protective layer 10 having the following composition to form the protective layer.

### <Coating Liquid for Protective Layer 10>

| | | |
|---|---|---|
| Acrylic resin (solid content 45%) | 190 | parts |
| (VINYBLAN(R) 2580, Nissin Chemical Co., Ltd.) | | |
| Ethoxylated alcohol (Mn: 2300, HLB value: 16) | 10 | parts |
| (UNITHOX(R) 480 ethoxylate, Baker Hughes Company) | | |
| Polyethylene wax | 5 | parts |
| Water | 350 | parts |
| Isopropyl alcohol | 145 | parts |

### Comparative Example 1

A thermal transfer sheet of Comparative Example 1 was obtained exactly in the same manner as in Example 1 except that the coating liquid for protective layer 1 was replaced by a coating liquid for protective layer A having the following composition to form the protective layer.

### <Coating Liquid for Protective Layer A>

| | | |
|---|---|---|
| Acrylic resin | 100 | parts |
| (DIANAL(R) BR-83, Mitsubishi Chemical Corporation) | | |
| Methyl ethyl ketone | 250 | parts |
| Toluene | 250 | parts |

### Comparative Example 2

A thermal transfer sheet of Comparative Example 2 was obtained exactly in the same manner as in Example 1 except that the coating liquid for protective layer 1 was replaced by a coating liquid for protective layer B having the following composition to form the protective layer.

### <Coating Liquid for Protective Layer B>

| | | |
|---|---|---|
| Acrylic resin | 90 | parts |
| (DIANAL(R) BR-83, Mitsubishi Chemical Corporation) | | |
| Polyethylene wax | 10 | parts |
| Methyl ethyl ketone | 250 | parts |
| Toluene | 250 | parts |

### Comparative Example 3

A thermal transfer sheet of Comparative Example 3 was obtained exactly in the same manner as in Example 1 except that the coating liquid for protective layer 1 was replaced by a coating liquid for protective layer C having the following composition to form the protective layer.

### <Coating Liquid for Protective Layer C>

| | | |
|---|---|---|
| Acrylic resin | 95 | parts |
| (DIANAL(R) BR-83, Mitsubishi Chemical Corporation) | | |
| Talc | 5 | parts |
| (MICRO ACE(R) P-3, Nippon Talc Co., Ltd.) | | |
| Methyl ethyl ketone | 250 | parts |
| Toluene | 250 | parts |

### Comparative Example 4

A thermal transfer sheet of Comparative Example 3 was obtained exactly in the same manner as in Example 1 except that the coating liquid for protective layer 1 was replaced by a coating liquid for protective layer D having the following composition to form the protective layer.

### <Coating Liquid for Protective Layer D>

| | | |
|---|---|---|
| Vinyl chloride-vinyl acetate copolymer | 95 | parts |
| (SOLBIN(R) C, Nissin Chemical Co., Ltd.) | | |
| Ethoxylated alcohol (Mn: 1400, HLB value: 10) | 5 | parts |
| (UNITHOX(R) 750 ethoxylate, Baker Hughes Company) | | |
| Methyl ethyl ketone | 250 | parts |
| Toluene | 250 | parts |

### (Production of Print)

From a genuine ribbon for a sublimable type thermal transfer printer (DS620, Dai Nippon Printing Co., Ltd.), in which a yellow dye layer, a magenta dye layer, a cyan dye layer, and a protective layer were repeatably disposed in this order, the protective layer portion was cut. Then, a thermal transfer sheet of each of Examples and Comparative Examples was prepared by placing the thermal transfer sheet of each of Examples and Comparative Examples on the protective layer portion cut and splicing the thermal transfer sheet of each of Examples and Comparative Examples placed on the protective layer portion to each adjacent dye layer portion. In other words, prepared was the thermal transfer sheet of each of Examples and Comparative Examples in which only the protective layer portion of the genuine ribbon was replaced by the thermal transfer sheet of each of Examples and Comparative Examples. Then, by using a sublimable-type thermal transfer printer (DS620, Dai Nippon Printing Co., Ltd.) and the thermal transfer sheet of each of Examples and Comparative Examples prepared above, a 0/255-gray scale (image gray scale) black solid image was printed on a genuine image receiving sheet of the sublimable-type thermal transfer printer as a transfer receiving article to provide an image body. Then, by using the above sublimable-type thermal transfer printer, the transfer layer of the thermal transfer sheet of each of Examples and Comparative Examples was transferred at 55/255 gray scale (image gray scale) on the image body obtained above to provide a print of each of Examples and Comparative Examples. In production of the print of any of Examples and Comparative Examples, it was confirmed that transfer of the transfer layer on the image body was achieved with satisfactory adhesion.

### (Abrasion Resistance Evaluation)

The region of the print of each of Examples and Comparative Examples obtained above, in which region the black solid image was formed, was cut into a piece having a width of 3 cm. By a method in compliance with JIS-L-0849 (2013), a 200-g weight was placed on the print with a test cloth interposed therebetween, and the test cloth was reciprocated by an abrasion tester. The number of reciprocations was determined when abrasion of the black solid image started in the reciprocated region, and the abrasion resistance was evaluated based on the following evaluation criteria. The evaluation results are shown in Table 1. As the abrasion tester type II (Gakushin-Type), an abrasion tester (abrasion tester FR-II, Suga Test Instruments Co., Ltd.) was used, and as the test cloth, Kanakin No. 3 (JIS-L-0803(2011)) was used.

### “Evaluation Criteria”

S: No scratching on the transfer layer cannot be observed at a reciprocation number of 3500.

A: Scratching on the transfer layer can be observed at a reciprocation number of 2750 or more and less than 3500.

B: Scratching on the transfer layer can be observed at a reciprocation number of 2250 or more and less than 2750.

C: Scratching on the transfer layer can be observed at a reciprocation number of 1500 or more and less than 2250.

D: Scratching on the transfer layer can be observed at a reciprocation number of 700 or more and less than 1500.

NG: Scratching on the transfer layer can be observed at a reciprocation number of 1 or more and less than 700.

### (Processing Suitability Evaluation)

The condition of the thermal transfer sheet of each of Examples and Comparative Examples when the sheet was squeezed by a hand was observed, and the processing suitability was evaluated based on the following evaluation criteria. The evaluation results are shown in Table 1.

### “Evaluation Criteria”

A: The transfer layer is not peeled from the thermal transfer sheet.

B: The transfer layer is peeled from the thermal transfer sheet.

TABLE 1

| | Abrasion | Processing |
|---|---|---|
| | resistance | suitability |
| Example 1 | D | A |
| Example 2 | S | A |
| Example 3 | C | A |
| Example 4 | B | A |
| Example 5 | S | A |
| Example 6 | A | A |
| Example 7 | A | A |
| Example 8 | A | A |
| Example 9 | A | A |
| Example 10 | S | B |
| Example 11 | S | A |
| Example 12 | S | A |
| Example 13 | D | A |
| Comparative Example 1 | NG | — |
| Comparative Example 2 | NG | — |
| Comparative Example 3 | NG | — |
| Comparative Example 4 | NG | — |

### REFERENCE SIGNS LIST

1 Substrate
5 Protective layer
6 Adhesive layer
7 Colorant layer
10 Transfer layer
100 Thermal transfer sheet
110 Support
120 Image layer
150 Image body
200 Print

1. A thermal transfer sheet in which a transfer layer is provided on one surface of a substrate, wherein
the transfer layer has a single-layer structure composed only of a protective layer or a layered structure including a protective layer located nearest from a side of the substrate, and
the protective layer contains an acrylic resin, an ethoxylated alcohol, and a polyethylene wax.

2. The thermal transfer sheet according to claim 1, wherein a number average molecular weight (Mn) of the ethoxylated alcohol is 2000 or less.

3. The thermal transfer sheet according to claim 1, wherein an HLB value of the ethoxylated alcohol is 12 or less.

4. The thermal transfer sheet according to claim 1, wherein a content of the ethoxylated alcohol is 2% by mass or more based on a total mass of the protective layer.

5. (canceled)

6. A print in which a protective layer is provided on an image body having an image, wherein the protective layer contains an acrylic resin and an ethoxylated alcohol.

7. The thermal transfer sheet according to claim 2, wherein a content of the ethoxylated alcohol is 2% by mass or more based on a total mass of the protective layer.

8. The thermal transfer sheet according to claim 3, wherein a content of the ethoxylated alcohol is 2% by mass or more based on a total mass of the protective layer.
